(19) United States
(12) Patent Application Publication
(10) Pub. No.: US 2021/0200751 A1
(43) Pub. Date: Jul. 1, 2021

(54) MONITORING AND DATA VALIDATION OF PROCESS LOG INFORMATION IMPORTED FROM MULTIPLE DIVERSE DATA SOURCES

(71) Applicant: Capital One Services, LLC, McLean, VA (US)

(72) Inventors: Naga Venkata SRIRAM VADAKATTU, Frisco, TX (US); Siva R. VEGESANA, Frisco, TX (US); Gowtham SATHIYANARAYANAN, Plano, TX (US); Eric FRY, Plano, TX (US); Pratap Kumar MITTAPALLI, Chennai (IN); Selvam MAYAVAN, Greenville, SC (US); Ashutosh UPADHYAY, Gwalior (IN)

(73) Assignee: Capital One Services, LLC, McLean, VA (US)

(21) Appl. No.: 16/731,641

(22) Filed: Dec. 31, 2019

(51) Int. Cl. G06F 16/248; G06F 16/25; G06F 16/2455; G06F 16/23

(52) U.S. Cl. CPC G06F 16/248; G06F 16/2358; G06F 16/2455; G06F 16/258

(57) ABSTRACT

Exemplary embodiments enable the importation of process log information from a wide variety of sources into target databases. The exemplary embodiments may properly import process log information from a variety of different types of data sources. Moreover, the exemplary embodiments can handle the importation from a large number of data sources on an ongoing basis. Process log information may originate in a source format, may be converted into a canonical format and then may be converted from the canonical format into the destination format of the target databases. The exemplary embodiments may provide data validation for the process log information. The exemplary embodiments may provide process monitoring based on the process log information that has been imported into the target database.

### BACKGROUND

Many large enterprises may run a large number of computing processes at a time. The processes may run across multiple servers that are dispersed geographically. These processes may concern different lines of business and relate to different subjects. System logs providing information regarding these processes may be stored in different formats on a wide variety of databases. As a result, it may be very difficult to monitor these processes. A disparate set of tools may be used to get a fragmented view of a subset of the processes.

### SUMMARY

In accordance with an exemplary embodiment, A computer-implemented method includes receiving at a computing device, having one or more processors, log information regarding processes executing in a web-based environment. The log information is encoded to reflect one of a plurality of lines of business for each of the processes and one of a plurality of subjects for each of the processes. The log information is processed with the one or more processors based on what is encoded in the log information to identify which of the processes are for a first of the lines of business. The log information is processed with the one or more processors based on how the log information is encoded to identify which of the processes are for a second of the lines of business. The log information is processed with the one or more processors based on how the log information is encoded to identify which of the processes are for a first subject. The log information is also processed with the one or more processors based on how the log information is encoded to identify which of the processes are for a second subject. A dynamic user interface is generated that includes user interface components that identify how many processes are for the first line of business, for the second business, for the first subject and for the second subject. The method may include the step of updating the dynamic user interface to reflect changing status of at least one of the processes.

The dynamic user interface may display information regarding the status of the processes. There may be multiple categories of status, and the dynamic user interface may specify how many of the processes are in respective ones of the categories. The dynamic user interface may provide a non-textual graphical visual cue of the status of at least one process. The dynamic user interface may include an activatable navigation component, and the activation of the navigation component on the dynamic user interface may result in navigation to a display of information regarding the processes for the first line of business. The dynamic user interface may include another activatable navigation component, and the activation of that navigation component on the dynamic user interface may result in navigation to a display of information regarding the processes for the first subject. In accordance with an exemplary embodiment, a computer-implemented method is performed. In this method, a source data store is queried to obtain a first unit of data at a computing device. A target data store is queried to obtain a first corresponding unit of data that corresponds with the first unit of data at the computing device. The first unit of data is converted into a canonical form with the computing device. The corresponding unit of data is converted into the canonical form with the computing device. The first unit of data in the canonical form is compared with the corresponding unit of data in the canonical form to identify any differences. Based on the comparing, a determination is made with the computing device if the first unit of data was successfully imported from the source data store to the target data store. An output reflective of the determining is generated from the computing device.

The determining may determine that the first unit of data was not successfully imported from the source data store. The output may contain information regarding at least one identified difference between the first unit of data and the second unit of data. The determining may determine that the first unit of data was successfully imported from the source data store. The source data source may hold system log information about processes and/or applications.

In accordance with an exemplary embodiment, a non-transitory computer-readable storage medium stores computer-executable instructions for execution on a processor of a computing device to perform the following. A source database of process log information is queried concerning processes to obtain a set of process log information for importation into a target database. The obtained set of process log information is converted into a format suitable for the target database. The obtained set of process log information is validated by comparing the obtained process log information with the converted obtained set of process log information. The converted obtained set of process log information is stored in the target database if the validating was successful. Information regarding whether the validating was successful is output. A user interface is displayed on a display device, wherein the user interface displays information regarding processes sorted by line of business and sorted by subject. In response to activation of a user interface component on the user interface, more information regarding processes for one of the lines of business is, and in response to activation of another user interface component on the user interfaces, more information is displayed regarding processes for a selected subject.

The validating may comprise converting data units in the obtained process log information into a canonical format and may comprise converting data units in the converted obtained process log information into the canonical format. The validating may comprise comparing converted data units from the obtained process log information in the canonical format with the converted data units from the converted obtained process log information in the canonical format to determine if they are sufficiently similar.

The medium may also store instructions for querying the target database to gain access to the process log information in the target database. The target database may hold application log information originating from multiple source databases. The multiple source databases may include at least two of different types. The validating comprises determining whether a count of processes for which process log information is obtained in the obtained process log information equals a count of applications for which process log information is in the converted obtained process log information.

### BRIEF DESCRIPTION OF THE DRAWINGS

FIG. 1 depicts a computing environment suitable for practicing an exemplary embodiment.

FIG. 2 depicts a block diagram of components of a process monitoring and data validation platform of an exemplary embodiment.

FIG. 3 depicts flow of data from a source database to a target database in an exemplary embodiment.

FIG. 4 depicts a flowchart of steps performed in validating data imported from an external source in an exemplary embodiment.

FIG. 5A depicts a flowchart of steps that may be performed to encode additional information regarding data that is being imported in an exemplary embodiment.

FIG. 5B depicts a flowchart of steps that may be performed to identify information regarding processes for a line of business and for a subject.

FIG. 6 depicts an illustrative user interface for showing information regarding processes sorted by line of business and by subject.

FIG. 7 depicts an illustrative validation report.

FIG. 8 depicts an illustrative errors list identifying errors that occurred with processes that may be shown on a user interface.

FIG. 9 depicts an illustrative process list that lists information regarding processes that may be shown on a user interface.

FIG. 10 depicts an illustrative user interface that displays detailed information regarding a process.

FIG. 11 depicts an illustrative process types list that may be shown on a user interface.

FIG. 12 depicts a block diagram of a computing device suitable for use in an exemplary embodiment.

### DETAILED DESCRIPTION

Conventional strategies for importing large amounts of data (so called “big data”) are limited in their capabilities. These conventional software tool focus almost solely on translating the data into a new format and storing the data in a new format. These conventional software tools do not provide additional capabilities. The exemplary embodiments, in contrast, provide additional capabilities that are helpful to information technology specialists that work with the importing and monitoring the data. The additional capabilities, for example, may provide validation, monitoring of enterprise wide processes in a single user interface and characterization of imported data by line of business and subject. The exemplary embodiments may provide a single software tool/environment for importing, translating, validating and monitoring process data enterprise wide for a large number of processes on an ongoing basis.

Exemplary embodiments may enable the importation of process log information from a wide variety of sources into target databases. The exemplary embodiments may import process log information from a variety of different types of data sources. For example, the process log information may originate from different types of databases (e.g., relational, object-oriented, etc.) and from databases from different vendors. Moreover, the exemplary embodiments can handle the importation from a large number of data sources on an ongoing basis. Process log information may originate in a source format, may be converted into a canonical format and then may be converted from the canonical format into the destination format of the target databases. The use of the canonical format helps to provide a generalized solution that works across different source data formats and target data formats.

During the translation process the line of business for the data (e.g., Marketing, Sales, etc.) may be determined from the source process log information and encoded, such as by a numeric code so that the line of business information is encoded with the data in the target database. Moreover, subject information may be determined from the source process log information and encoded such as by a numeric code so that that the subject is encoded with the data in the target database. For example, suppose that the data is for the “Loans” line of business and the data relates to a loan application, the subject may then be “loan application.”

The exemplary embodiments may provide data validation for the process log information. The validation may entail comparing the source process log information with the destination process log information. The comparison may help determine if the information from the source process log information was properly translated into the destination process log information. This may involve ensuring that the content in the destination process log information has not changed relative to the source log information and that data was not lost in the translation process. The formats of the respective source process log information and the destination process log information may, however, differ.

Exemplary embodiments may provide a platform that acts as a single destination for obtaining information regarding processes that execute in a given enterprise. For example, information regarding the processes for a given department, division or a given corporation may be accessible via the platform. The platform may also act as a single destination for accessing process logs.

The exemplary embodiments may provide process monitoring based on the process log information that has been imported into the target databases. The monitoring may display useful information regarding processes for which process log information is imported on an ongoing basis. For example, process information may be displayed based on line of business and/or subject. The process log information may be analyzed to provide information regarding current statuses of processes. The monitoring may provide information regarding errors and failures. The monitoring may also provide detailed information about a process.

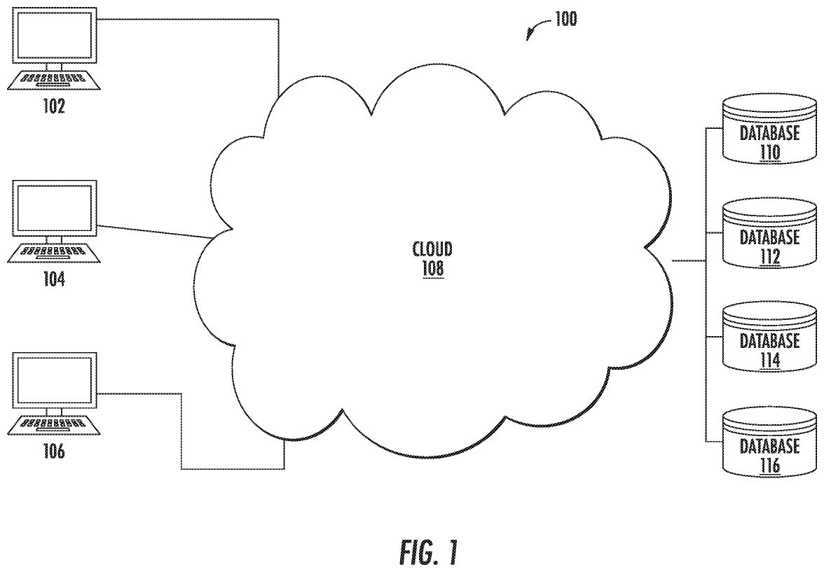

FIG. 1 shows an illustrative environment 100 in which an exemplary embodiment may be practiced. Client computing devices 102, 104 and 106 may be connected to a network cloud 108. The client computing devices 102, 104 and 106 may be used by clients to gain access to the monitoring and validation platform over the cloud 108. The client computing devices 102, 104 and 106 may take different forms. The client computing devices 102, 104 and 106 may be desktop computers, laptop computers, table computers, smart phones, workstations, smart televisions or other computing devices capable of accessing and interfacing with the monitoring and validation platform, which may be resident on the network cloud 108, such as on a server computing device. Multiple databases 110, 112, 114 and 116 may be interfaced with the network cloud 108. These databases 110, 112, 114 and 116 may be of different types (e.g., SQL databases, object-oriented databases, etc.) and may be produced by different vendors. These databases 110, 112, 114 and 116 may hold the source process logs for processes of an enterprise that are to be imported into the target databases discussed above. The target database and the platform may reside on the network cloud 108. In alternative embodiments, the target databases and the platform may be resident on private networks and interface with a public network like the Internet or a private web-based network.

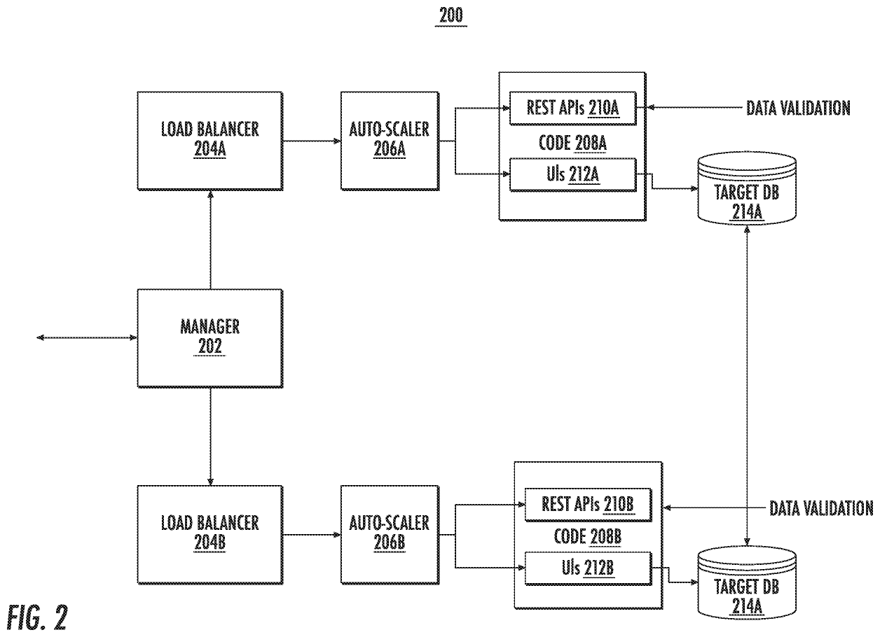

FIG. 2 depicts a block diagram of components of the platform and target database implemented in a cloud-based environment 200. The implementation may be realized on a commercial cloud service, such as on Amazon Web Services from Amazon.com, Inc or on Microsoft Azure web services from Microsoft Corporation. A manager 202 receives requests and directs the requests to the proper destination for handling. There may redundancy in components to handle different regions or more generally to provide more capacity. The manager 202 may pass an incoming request to one of the load balancers 204A or 204B. The load balancers 204A, 204B are responsible for balancing the load on respective servers in the cloud services. The programming code for performing the requested functionality may be implemented on multiple servers. To balance the load on the servers, the load balancers 204A, 204B may direct an incoming request to a server that is not busy rather than a server that is busy. The request may pass to an auto-scaler 206A or 206B, which scales the size of a cluster on which the deployed programming code is deployed.

Incoming request may be handled by code 208A, 208B. The code 208A, 208B includes REpresentational State Transfer (REST) application program interfaces (APIs) 210A, 210B for handling requests. The APIs provide PUT and POST of status information relative to the target databases 214A, 214B. These APIs 210A, 210B also facilitate retrieving status information for the monitoring user interface discussed below and the retrieving of data validation information. The code also includes program instructions 212A, 212B relating to the querying of the target databases 214A, 214B and displaying the monitoring user interface.

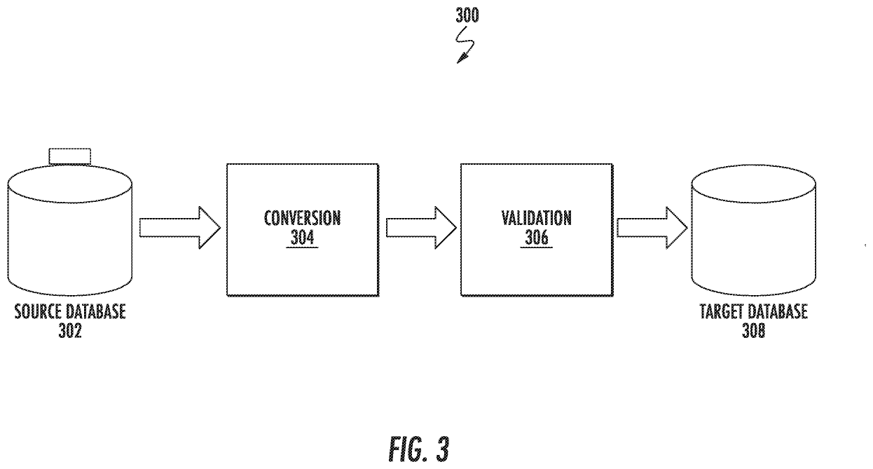

FIG. 3 depicts a diagram 300 illustrating the flow of data from a source database 302 to a target database 308. The data is extracted from the source database 302 and subject to conversion 304. The conversion 304 converts the extracted data into a target format for the target database 308. A canonical data format may be used to provide a more generalizable and extensible solution than conventional approaches. The target data is first converted into the canonical format and then converted from the canonical format to a target data format. The exemplary embodiments provide generalizability that enables the translation to be performed with a wide variety of source data formats and target data formats.

The use of the canonical format as an intermediary format enables the translation of process data to be realized through a modularized solution. Specifically, each source data format may have an associated module, such as a function, library, object method or the like, that translates the source data in the source data format into the canonical format. For each source data format, there is no need to be concerned with the target format; rather what is needed is code for converting the source data format into the canonical format. Similarly, each target data format may have a module, such as a function, library, object method or the like, that translates the canonical format into the target data format. The module need not be concerned with the source data format. Hence, the exemplary embodiments may be readily extensible to new source data formats and new target data formats. All that is needed is a new module for the new data format. Adding a new source data format or a new target data format does not require rewriting the entire translation code. Instead, only a new module is required. The module need not be extremely complex as the module only needs to convert between a canonical format and a source or target format in the desired translation direction.

At the time of translation the data may be tagged with line of business information and/or subject information as will be described in more detail below. The line of business and/or subject information may be determined based on application/process information in the logs of the source database. The line of business and subject information may be used to aggregate data and used as sort keys for information. This may be useful in generating reports, metrics and the like.

Validation 306 is then performed to ensure that the conversion did not result in the loss of any information content. Many conventional translation approaches may result in the loss of data or the modification of data. These conventional approaches do not provide a mechanism for identifying what data is loss or modified. The validation is customizable such that a user may choose what validation tests are performed on the translated data. The validated data in the target format is added to the target database 308. Thus, the log information may be extracted from the target database and stored in the target database in an ongoing fashion so that the status of many processes can be monitored.

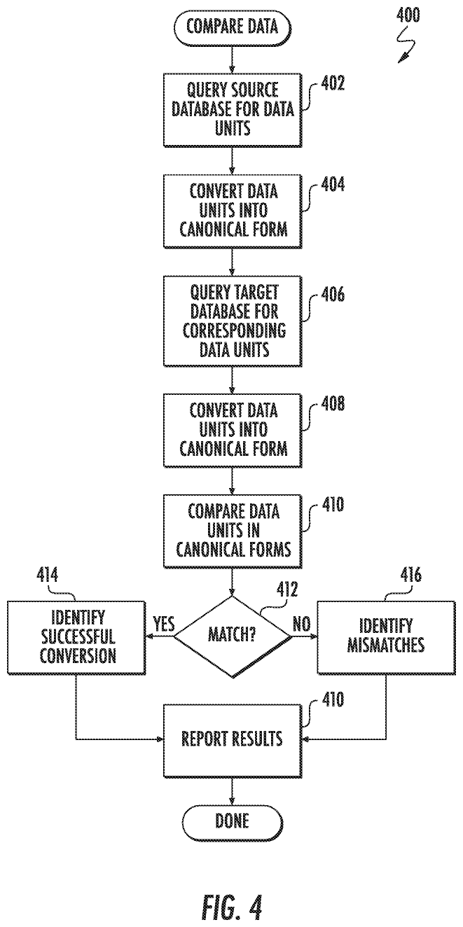

FIG. 4 shows a flowchart 400 illustrating the steps that may be performed as part of the validation 306. Initially, the source database 302 is queried for data units (402). The extracted data units that result from the query are converted into a canonical format (404). The canonical format is a standardized intermediate format. The target database is queried for the corresponding data (406), and the resulting data is converted into the canonical format (408). The data from the source database 302 in the canonical format and the data from the target database 308 in the canonical format are compared (410) to see if the data match (412). If the data matches, the conversion is identified as successful (414). If not, the mismatches in the data from the respective databases 302 and 308 are identified (416). The results of the comparing are reported (418). For instance, the results may be reflected in a message or a report.

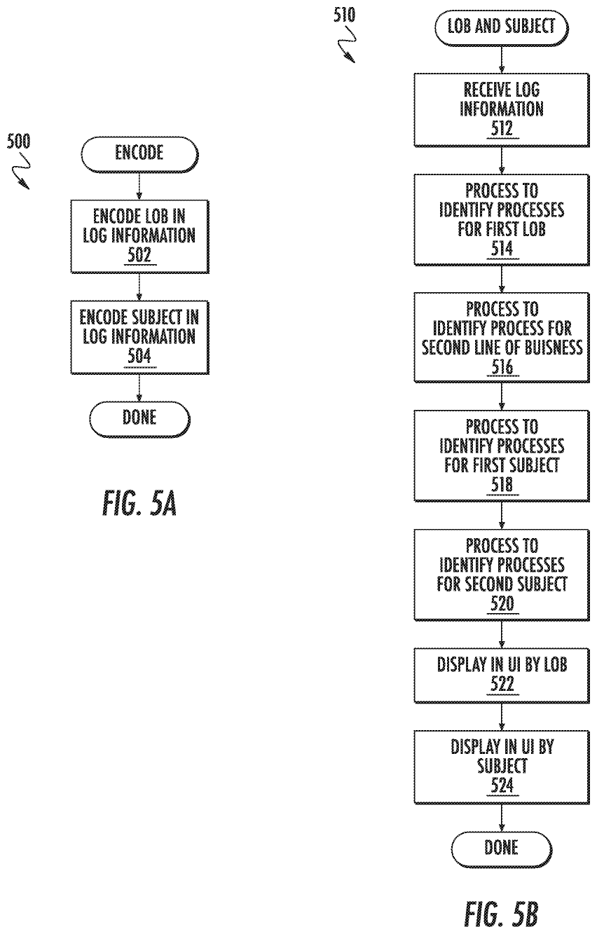

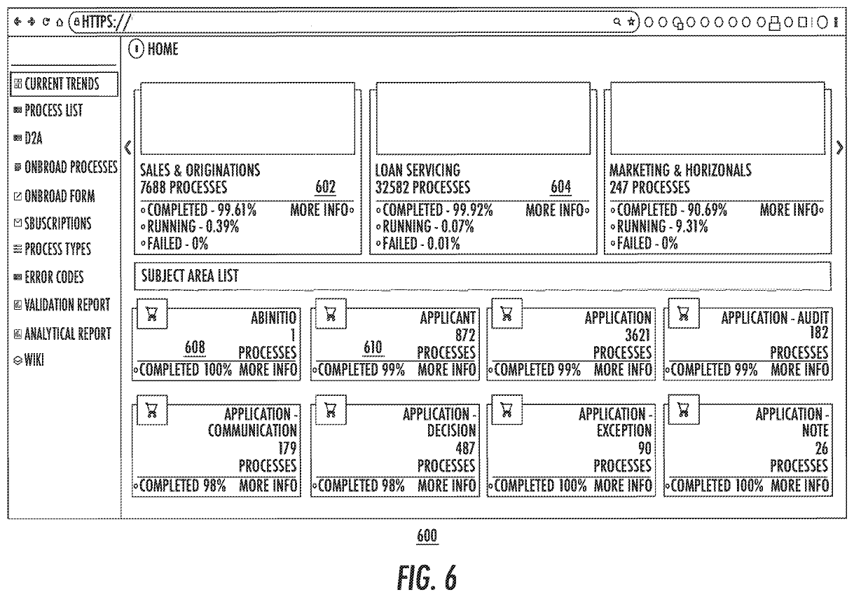

When the data is extracted from the external data sources, line of business information and subject information may be encoded in the log information that is added to the target databases 214A and 214B. As was discussed above, this can be helpful in generating reports, aggregating data by subject or line of business and displaying process information on a user interface. FIG. 5A depicts a flowchart 500 of this process. Based on the source of the information (e.g., the process or application and the associated logs) and the nature of the data, the line of business and subject may be determined. For example, if the source database is on a server in the loan servicing department and the data relates to loan applications, the incoming information may be encoded to reflect line of business and subject. Thus, as shown in FIG. 5A, the incoming data is encoded with a code (such as a numeric code) indicating the line of business (LOB) (502). The data is also encoded with a subject code (504). Examples of subjects for a Loans line of business may be “application”, “application decision” or “application exceptions,” such as depicted in FIG. 6 and as discussed below. These codes can be used when sorting process information by line of business and subject for display on the monitoring user interface.

FIG. 5B depicts a flowchart 510 that illustrates an example of how the line of business and subject information may be used in an exemplary embodiment. First. The log information is received (512), such as from one or more of the target databases 214A, 214B. The log information is processed to identify processes that are associated with a first line of business (514). The log information is also processed to identify processes for a second line of business (516). The log information is processed to identify processes associated with a first subject (518) and a second subject (520). The monitoring user interface may then display the processes by line of business (522) and or by subject (524).

The exemplary embodiments may provide a single place for a user to see information regarding processes across an enterprise where there are a large number of processes and a large amount of process related data. Data mining can be performed on the imported data via a user interface. Conventionally, there is a not a single place where all such information can be found and accessed, especially for big data environments. FIG. 6 shows an example of a monitoring user interface 600 for monitoring processes enterprise wide and generating screens and/or reports as will be described below. The user interface 600 may include elements, such as elements 602 and 604, that display information regarding processes by line of business. For instance, user interface element 602 display information regarding processes associated with the sales and origination line of business. The user interface element 602 shows that there are 7688 processes associated with this line of business. The user interface 600 breaks down by percentage what portion of the processes completed, are running and failed. User interface element 604 display similar information regarding processes in the loan servicing line of business.

FIG. 6 also shows user interface elements, such as elements 608 and 610, sorted by subject. User interface element 608 is associated with the subject Application”, whereas user interface element 610 is associated with the subject “Applicant”. Information regarding how many processes are associated with the respective subjects may be displayed, and information regarding what percentage of the processes completed may be shown as depicted in FIG. 6. Hence, due to the addition of the subject information, an exemplary embodiment may identify processes associated with each subject and generate screens and/or reports regarding the processes associated with the subject. The user interface 600 shown in FIG. 6 provides a single place to see information across processes sorted by subject

The user interface elements for line of business 602 and 604 and for subject 608 and 610 may be selected to drill down and provide an additional level of detail. The user interface elements include a selectable element to get “more info”.

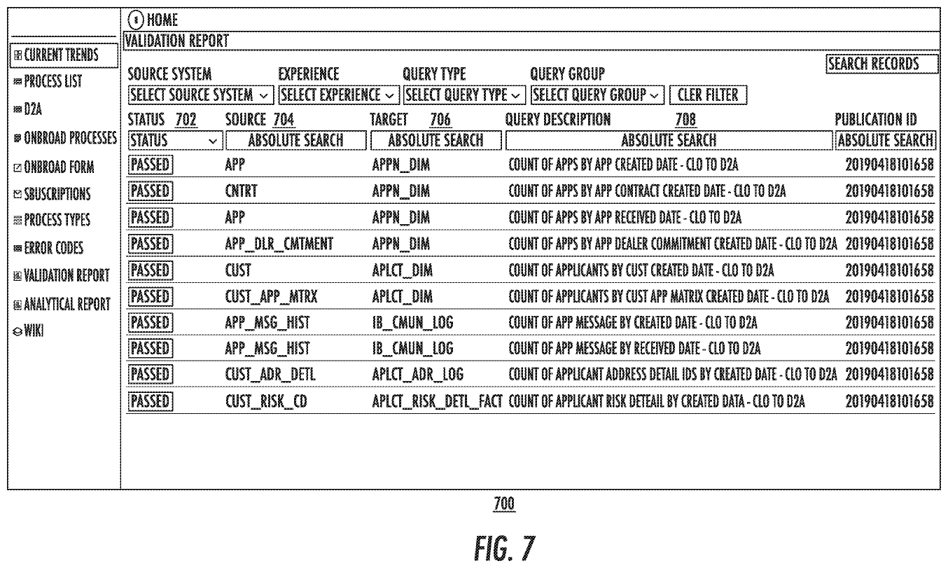

The monitoring user interface can provide information regarding data validation for data imported into the platform as described above. FIG. 7 shows an example of a validation report 700 that may be generated and displayed on the user interface. As was mentioned above, the validation may check whether data was lost and whether data was modified. The user may customize the validation tests that are performed. Conventional approached do not provide these capabilities. The validation report may include a column 702 for status, a column 704 for source, a column 706 for the target and a column 708 for query description. Thus, for example, as shown in the first row, the data validation status is “passed” for data originating from “APP” and targeted for “APPN_DIM”. The query related to the count of apps created by creation date. These tests check whether any data was lost in the translation from source to target, and each counts items for the source and target to make sure nothing is lost in the translation.

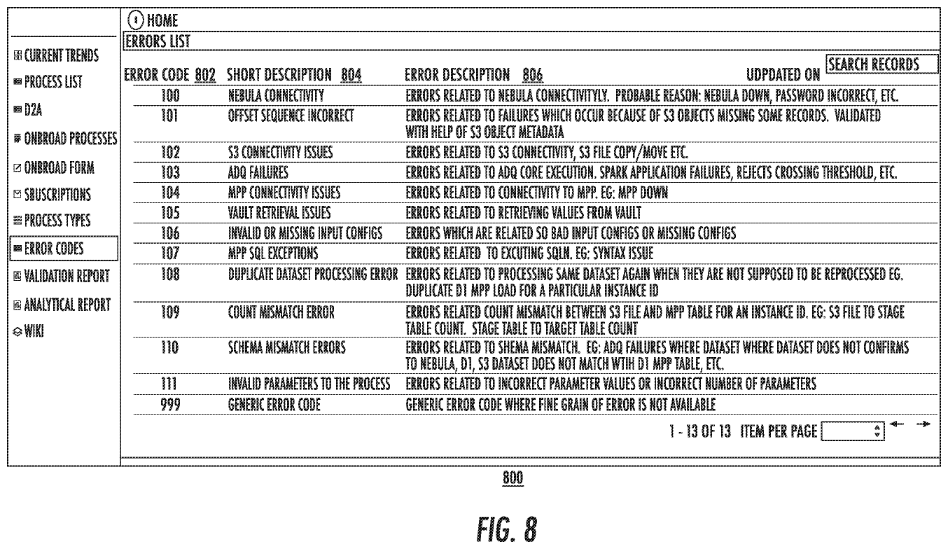

The monitoring of the processes allows a user to see errors that arise for the processes. The errors are encoded by numeric codes. If the user is interested in seeing what error codes mean, the user may display the errors list 800 as shown in FIG. 8. The errors list 800 lists each error code 802, provides a short description 804 of the associated error and a more detailed description 804. The user may use the error codes to identify and solve problems with processes.

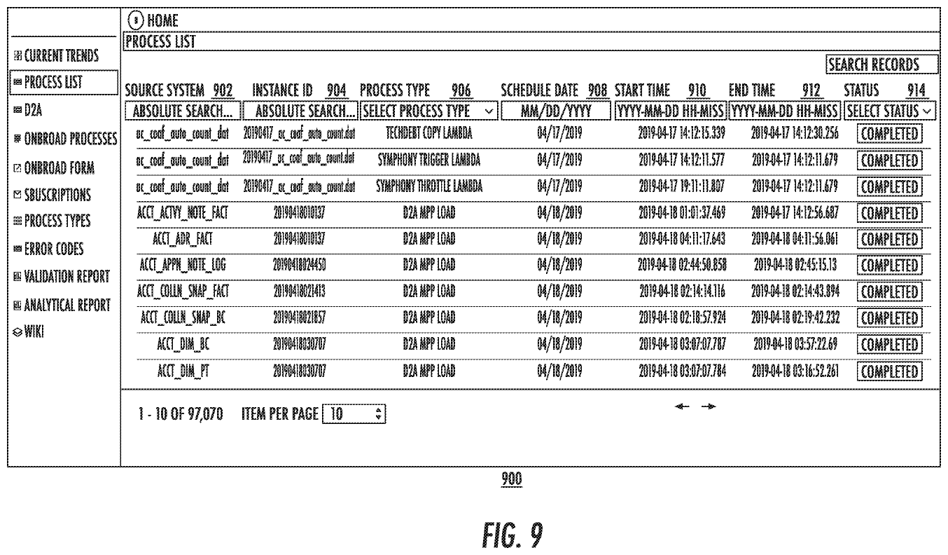

As was mentioned above, the exemplary embodiments may provide a single user interface for monitoring processes enterprise wide. Hence, a user can see information regarding processes relating to different lines of business and different subjects. A user may via the user interface see a list of all of the processes by pulling up the processes list 900 (FIG. 9). In the example of FIG. 9, there are over 97,000 processes and the portion of the list shown in FIG. 9 is just the first page of the list. For each process (i.e., each row), the name 902 and the instance ID of the process 904 may be displayed. The process type 906 also may be displayed. The schedule date 908, the start time 910 and the end time 912 for the process may be displayed. Lastly, a status 914 (such as “completed”) may be displayed.

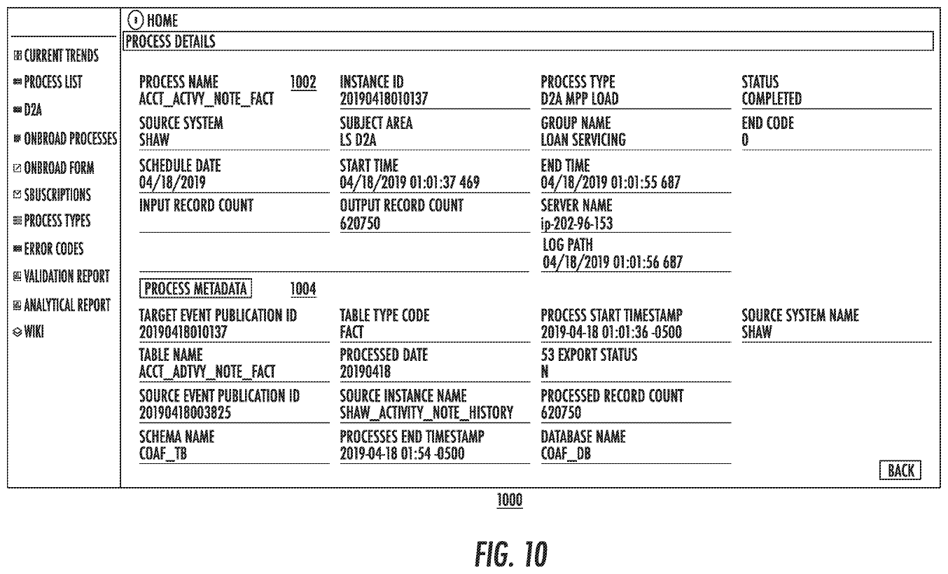

A user may drill down to get more detail regarding a process. Thus, for each of the large number of processes (e.g., over 97.000), the user interface allows a party to gain more fine grain information regarding the process. FIG. 10 shows an example of a user interface 1000 that shows additional detail regarding a process. The user interface 1000 includes a section 1002 that provides process details, such as name, type, status, subject area, server name and the like. Section 1004 shows metadata for the process. Through this user interface 1000, the user can gain much more detail regarding a process of interest.

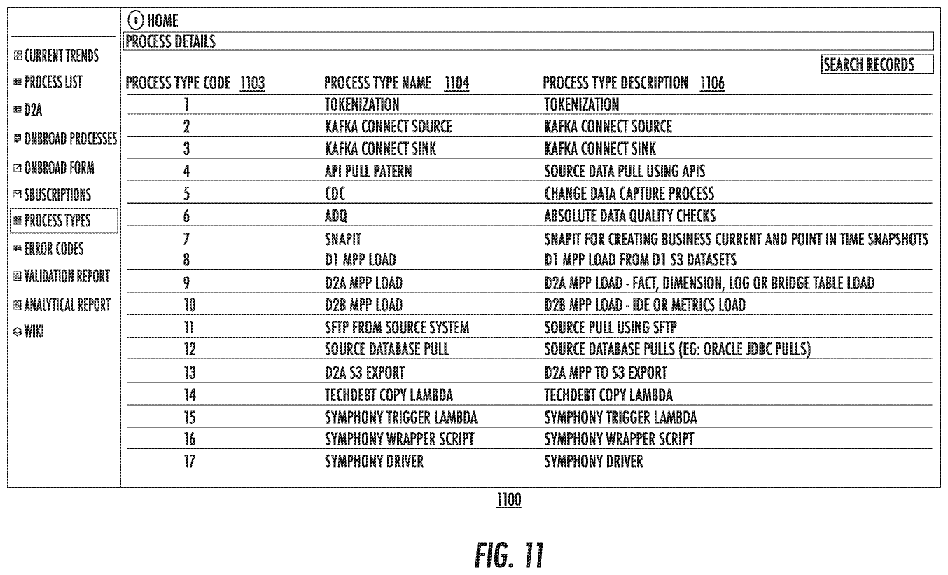

A user can look at a listing of process types 1100 (FIG. 11) to better understand process type codes and what variety of processes are being monitored. The listing specifies process type code 1102, which in this instance is a numeric code identifying a process type. The listing 1100 also specifies the name of the process type 1104. Lastly, the listing may provide a description of the process type 1106.

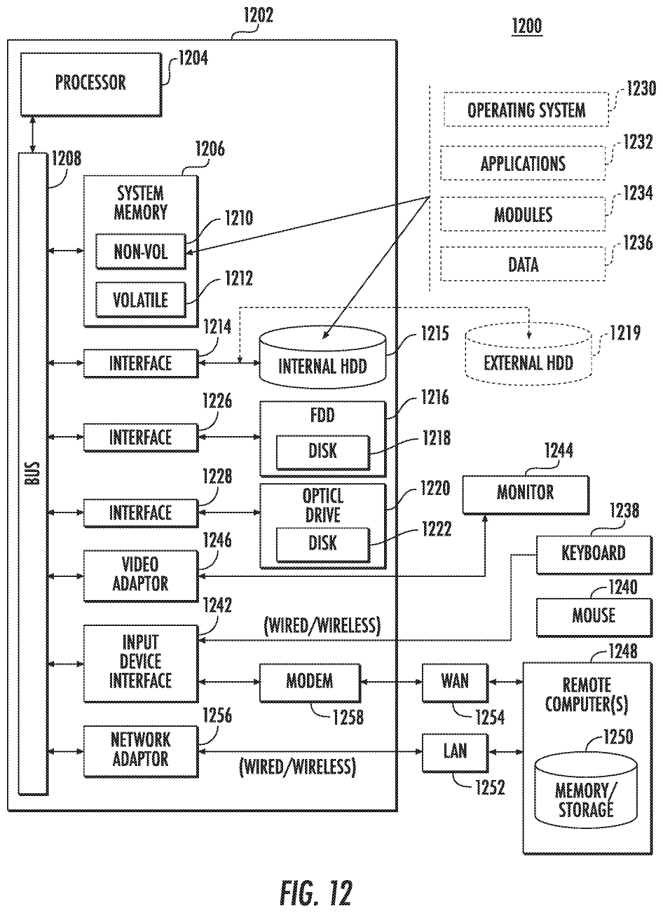

The methods described herein may be performed by a computing environment 1200, such as that depicted in FIG. 12. FIG. 12 illustrates an embodiment of an exemplary computing environment 1200 that includes a computing device 1202 that may be suitable for implementing various embodiments as previously described. In various embodiments, the computing environment 1200 may comprise or be implemented as part of an electronic device. More generally, the computing environment 1200 is configured to implement all logic, applications, systems, methods, apparatuses, and functionality described herein with reference to FIGS. 1-11.

As used in this application, the terms “system” and “component” and “module” are intended to refer to a computer-related entity, either hardware, a combination of hardware and software, software, or software in execution, examples of which are provided by the exemplary computing environment 1200. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing device 1202 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing device 1202.

As shown in FIG. 12, the computing device 1202 includes a processor 1204, a system memory 1206 and a system bus 1208. The processor 1204 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi processor architectures may also be employed as the processor 1204.

The system bus 1208 provides an interface for system components including, but not limited to, the system memory 1206 to the processor 1204. The system bus 1208 can be any of several types of bus structure that may further interconnect to a memory bus (with or without a memory controller), a peripheral bus, and a local bus using any of a variety of commercially available bus architectures. Interface adapters may connect to the system bus 1208 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1206 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 12, the system memory 1206 can include non-volatile memory 1210 and/or volatile memory 1212. A basic input/output system (BIOS) can be stored in the non-volatile memory 1210.

The computing device 1202 may include various types of computer-readable storage media in the form of one or more lower speed memory units, including an internal (or external) hard disk drive (HDD) 1214, a magnetic floppy disk drive (FDD) 1216 to read from or write to a removable magnetic disk 1218, and an optical disk drive 1220 to read from or write to a removable optical disk 1222 (e.g., a CD-ROM or DVD). The HDD 1214, FDD 1216 and optical disk drive 1220 can be connected to the system bus 1208 by an HDD interface 1224, an FDD interface 1226 and an optical drive interface 1228, respectively. The HDD interface 1224 for external drive implementations can include at least one or both of Universal Serial Bus (USB) and IEEE 1394 interface technologies. The computing device 1202 is generally is configured to implement all logic, systems, methods, apparatuses, and functionality described herein with reference to FIGS. 1-11.

The drives and associated computer-readable media provide volatile and/or nonvolatile storage of data, data structures, computer-executable instructions, and so forth. For example, a number of program modules can be stored in the drives and memory units 1210, 1212, including an operating system 1230, one or more application programs 1232, other program modules 1234, and program data 1236. In one embodiment, the one or more application programs 1232, other program modules 1234, and program data 1236 can include, for example, the various applications and/or components of the system

A user can enter commands and information into the computing device 1202 through one or more wire/wireless input devices, for example, a keyboard 1238 and a pointing device, such as a mouse 1240. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 1204 through an input device interface 1242 that is coupled to the system bus 1208 but can be connected by other interfaces such as a parallel port, IEEE 1394 serial port, a game port, a USB port, an IR interface, and so forth.

A monitor 1244 or other type of display device is also connected to the system bus 808 via an interface, such as a video adaptor 1246. The monitor 1244 may be internal or external to the computing device 1202. In addition to the monitor 1244, a computer typically includes other peripheral output devices, such as speakers, printers, and so forth.

The computing system 1202 may operate in a networked environment using logical connections via wire and/or wireless communications to one or more remote computers, such as a remote computer 1248. The remote computer 1348 can be a workstation, a server computer, a router, a personal computer, portable computer, microprocessor-based entertainment appliance, a peer device or other common network node, and typically includes many or all of the elements described relative to the computing system 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computing device 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computing device 1202 can include a modem 1258, or is connected to a communications server on the WAN 1254, or has other means for establishing communications over the WAN 1254, such as by way of the Internet. The modem 1258, which can be internal or external and a wire and/or wireless device, connects to the system bus 1208 via the input device interface 1242. In a networked environment, program modules depicted relative to the computing device 1202, or portions thereof, can be stored in the remote memory/storage device 1250. It will be appreciated that the network connections shown are exemplary and other means of establishing a communications link between the computers can be used.

The computing device 1202 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

1. A computer-implemented method, comprising:
receiving at a computing device, comprising one or more processors, log information regarding processes executing in a web-based environment, wherein the log information is encoded to reflect one of a plurality of lines of business for each of the processes and one of a plurality of subjects for each of the processes;
processing the log information with the one or more processors based on what is encoded in the log information to identify which of the processes are for a first of the lines of business;
processing the log information with the one or more processors based on how the log information is encoded to identify which of the processes are for a second of the lines of business;
processing the log information with the one or more processors based on how the log information is encoded to identify which of the processes are for a first subject;
processing the log information with the one or more processors based on how the log information is encoded to identify which of the processes are for a second subject; and
generating a dynamic user interface that includes user interface components that identify how many processes are for the first line of business, for the second business, for the first subject and for the second subject.

2. The method of claim 1, wherein the dynamic user interface displays information regarding a status of the processes.

3. The method of claim 2, wherein there are multiple categories of status and the dynamic user interface specifies how many of the processes are in respective ones of the categories.

4. The method of claim 3, wherein the dynamic user interface provides a non-textual graphical visual cue of the status of at least one process.

5. The method of claim 1, wherein the dynamic user interface includes an activatable navigation component and activation of the navigation component on the dynamic user interface results in navigation to a display of information regarding the processes for the first line of business.

6. The method of claim 1, wherein the dynamic user interface includes an activatable navigation component and activation of the navigation component on the dynamic user interface results in navigation to a display of information regarding the processes for the first subject.

7. The method of claim 1, further comprising, updating the dynamic user interface to reflect changing status of at least one of the processes.

8.-12. (canceled)

13. A non-transitory computer-readable storage medium storing computer-executable instructions for execution on a processor of a computing device to perform the following:
querying a source database of process log information concerning processes of applications to obtain a set of process log information for importation into a target database;
converting the obtained set of process log information into a format suitable for the target database, as part of the converting, tagging the process log information with line of business information and/or subject information;
validating the obtained set of process log information by comparing the obtained process log information with the converted obtained set of process log information;
storing the converted obtained set of process log information in the target database if the validating was successful;
outputting information regarding whether the validating was successful;
displaying a user interface on a display device, wherein the user interface displays information regarding processes sorted by line of business and sorted by subject based at least in part on the tagged information;
in response to activation of a user interface component on the user interface, displaying more information regarding processes for one of the lines of business; and
in response to activation of another user interface component on the user interfaces, displaying more information regarding processes for a selected subject.

14. The non-transitory computer-readable storage medium of claim 13, wherein the validating comprises converting data units in the obtained process log information into a canonical format.

15. (canceled)

16. The non-transitory computer-readable storage medium of claim 14, wherein the validating comprises comparing converted data units from the obtained process log information in the canonical format with the converted data units from the converted obtained application log information in the canonical format to determine if they are sufficiently similar.

17. The non-transitory computer-readable storage medium of claim 13, further storing instructions for querying the target database to gain access to the process log information in the target database.

18. The non-transitory computer-readable storage medium of claim 13, wherein the target database holds process log information originating from multiple source databases.

19. The non-transitory computer-readable storage medium of claim 18, wherein the multiple source databases include at least two of different types.

20. The non-transitory computer-readable storage medium of claim 13, wherein the validating comprises determining whether a count of processes for which log information is obtained in the obtained application log information equals a count of applications for which process log information is in the converted obtained process log information.

21. A computer-implemented method, comprising:
querying a source database of process log information concerning processes of applications to obtain a set of process log information for importation into a target database;
converting the obtained set of process log information into a format suitable for the target database, as part of the converting, tagging the process log information with line of business information and/or subject information;
validating the obtained set of process log information by comparing the obtained process log information with the converted obtained set of process log information;
storing the converted obtained set of process log information in the target database if the validating was successful;
outputting information regarding whether the validating was successful;
displaying a user interface on a display device, wherein the user interface displays information regarding processes sorted by line of business and sorted by subject based at least in part on the tagged information;
in response to activation of a user interface component on the user interface, displaying more information regarding processes for one of the lines of business; and
in response to activation of another user interface component on the user interfaces, displaying more information regarding processes for a selected subject.

22. The method of claim 21, wherein the validating comprises converting data units in the obtained process log information into a canonical format.

23. The method of claim 22, wherein the validating comprises comparing converted data units from the obtained process log information in the canonical format with the converted data units from the converted obtained application log information in the canonical format to determine if they are sufficiently similar.

24. The method of claim 21, further comprising querying the target database to gain access to the process log information in the target database.

25. The method of claim 21, wherein the target database holds process log information originating from multiple source databases.

26. The method of claim 21, wherein the validating comprises determining whether a count of processes for which log information is obtained in the obtained application log information equals a count of applications for which process log information is in the converted obtained process log information.
